(19) United States
(12) Patent Application Publication
(10) Pub. No.: US 2019/0110256 A1
(43) Pub. Date: Apr. 11, 2019

(54) DEVICE AND METHOD FOR A WIRELESS COMMUNICATION SYSTEM

(71) Applicant: Huawei Technologies Co., Ltd., Shenzhen (CN)

(72) Inventor: Antti IMMONEN, Kista (SE)

(21) Appl. No.: 16/212,910

(22) Filed: Dec. 7, 2018

Related U.S. Application Data
(63) Continuation of application No. PCT/EP2016/062991, filed on Jun. 8, 2016.

(51) Int. Cl. H04W 52/14; H04W 52/36; H04W 52/42; H04B 7/0413; H04L 1/00

(52) U.S. Cl. CPC H04W 52/146; H04W 52/367; H04L 1/0025; H04B 7/0413; H04W 52/42

(57) ABSTRACT

A device (100) for a wireless communication system (500) is described, the device comprising: a radio transceiver (102) configured to transmit data signals in a plurality of different supported transmit Multiple Input Multiple Output, MIMO, TX-MIMO, modes. The radio transceiver (102) is further configured to transmit capability information including power information indicating a maximum output power for at least one of the plurality of different supported TX-MIMO modes. A network node (200) for the communication system (500) and methods for the device (100) and the network node (200) are also described.

### CROSS-REFERENCE TO RELATED APPLICATIONS

This application is a continuation of International Application No. PCT/EP2016/062991, filed on Jun. 8, 2016, the disclosure of which is hereby incorporated by reference in its entirety.

### TECHNICAL FIELD

The present application relates to a device and methods for a wireless communication system.

### BACKGROUND

In future radio technologies such as 5G it is envisioned that Multiple Input Multiple Output, MIMO, would be one of the means to achieve higher data rates. In Transmission MIMO, TX-MIMO, there are n parallel radio TX paths, each transmitting a dedicated signal. In 5G it is envisioned that TX-MIMO with up to 4 or 8 parallel TX paths will be standardized in 3rd Generation Partnership Project, 3GPP. Currently TX-MIMO a.k.a. Uplink MIMO, UL-MIMO, is not much used in cellular devices mostly due to lack of suitable applications and the fact that UL data capability rarely is the limiting factor in User Equipment, UE. Currently only 2 TX MIMO is standardized in 3GPP.

The most common LTE UE power class is 23 dBm which means that the UE maximum output power measured in the antenna connector is 23 dBm. Currently it is assumed that each Power Amplifier, PA, in a UE is able to deliver full UE power to the antenna connector, i.e. 23 dBm. There are also other power classes but those are not used in MIMO applications. This assumption comes from the fact that each PA in a UE needs to be able to operate in single-chain mode. PAs are expensive and space-hungry, so UEs are built in a way that the number of PAs is minimized leading to situation that each PA needs to serve at least one frequency band in single-chain mode. Accounting for instance for 5 dB RF Front-end losses, each PA generates max 28 dBm power. However, in TX-MIMO mode, the UE maximum power is still 23 dBm meaning that each PA has to apply 3 dB back-off in order not to violate emission requirements and/or regulatory rules. In other words, if TX-MIMO dedicated PA were used, 2TX MIMO could be implemented with one full power PA and one PA capable to deliver full power −3 dB. Typically a UE can signal its capabilities, e.g TX-MIMO layers=2 means that UE supports TX-MIMO with two parallel TX paths. The UE can meet UE powerclass 23 dBm by using either of the options of two full power PAs or one full power PA providing full power-3 dB PA.

However, adding more MIMO layers will bring in problems and/or inefficiencies that are not easily solved.

### SUMMARY

An objective of embodiments of the present application is to provide a device and a method for a wireless communication system which diminishes the problems with conventional solutions.

Another objective of the present application is to provide a device and a method for a wireless communication system which provides the possibility to transmit in additional TX-MIMO layers compared to the TX-MIMO layers which traditional devices are capable of transmitting in.

A further objective of the present application is to provide a device and a method for a wireless communication system which provides the possibility to transmit in additional TX-MIMO layers compared to the TX-MIMO layers which traditional devices are capable of transmitting in and which is easily implemented.

The above objectives are fulfilled by the subject matter of the independent claims. Further advantageous implementation forms of the present application can be found in the dependent claims.

According to a first aspect of the present application a device for a wireless communication system is provided, the device comprising a radio transceiver configured to transmit data signals in a plurality of different supported transmit Multiple Input Multiple Output, MIMO, TX-MIMO, modes; wherein the radio transceiver is further configured to transmit capability information including power information indicating a maximum output power for at least one of the plurality of different supported TX-MIMO modes.

With a device according to the first aspect of the application the radio transceiver may have different maximum output power in the different TX-MIMO modes. This greatly facilitates the design of the device. With a device according to the first aspect the device may be constructed with power amplifiers of only two different sizes, only one of which being a power amplifier with full output power and the remainder of the power amplifiers being power amplifiers with a reduced output power. Power amplifiers with a reduced output power are cheaper to produce, easier to integrate, and require less space on the circuit board.

In a first possible implementation form of a device according to the first aspect the radio transceiver is further configured to include in the capability information TX-MIMO support information indicating the plurality of different supported TX-MIMO modes. By transmitting such capability information, a network node receiving the capability information gets information on which TX-MIMO modes that are supported by the device.

In a second possible implementation form of a device according to the first possible implementation form the radio transceiver is further configured to indicate, in the TX-MIMO support information, only the highest supported TX-MIMO mode of the plurality of different supported TX-MIMO modes. This minimizes the amount of information sent with the capability information. Based on this information, the receiving end (e.g. a base station can conclude that the device also supports all lower TX-MIMO modes).

In a third possible implementation form of a device according to the first or second possible implementation form the radio transceiver is further configured to transmit the capability information in a single message. This optimises the sending of information.

In a fourth possible implementation form of a device according to any of the first to the third implementation form or to the first aspect as such the device belongs to a predefined power class having a predefined maximum output power; wherein the radio transceiver is configured to include in the power information the maximum output power for each of the plurality of different supported TX-MIMO modes, for which the maximum output power is below the predefined maximum output power. This is the minimum amount of information that has to be sent. The network node receiving the information only needs to know the maximum output power for each of the plurality of different supported TX-MIMO modes, for which the maximum output power is below the predefined maximum output power as it will presume that the maximum output power for the remaining modes is the predefined maximum output power.

In a fifth possible implementation form of a device according to the fourth possible implementation form the radio transceiver is configured to not include in the power information the maximum output power for each of the plurality of different supported TX-MIMO modes, for which the maximum output power is equal to the predefined maximum output power. This minimizes the amount of information sent from the device.

In a sixth possible implementation form of a device according to any of the first to fifth possible implementation forms or to the first aspect as such, the radio transceiver is further configured to transmit data signals in a single transmit mode; wherein a maximum output power for the single transmit mode is equal to a maximum output power of the TX-MIMO mode or TX-MIMO modes of the plurality of different supported TX-MIMO modes having the highest maximum output power.

In a seventh possible implementation form of a device according to any of the first to sixth possible implementation forms or to the first aspect as such the plurality of different supported TX-MIMO modes comprises 2 layers TX-MIMO mode, 4 layers TX-MIMO mode and 8 layers TX-MIMO mode. These TX-MIMO modes are the ones presently contemplated by persons skilled in the art for transmission from a device.

In an eighth possible implementation form of a device according to the seventh possible implementation form the radio transceiver is configured to include in the power information the maximum output power for the 2 layers TX-MIMO mode and the 4 layers TX-MIMO mode. These modes are most commonly contemplated for transmission from a device.

In a ninth possible implementation form of a device according to the eighth possible implementation form the radio transceiver is configured to omit including in the power information the maximum output power for the 8 layers TX-MIMO mode. The reason for omitting the maximum output power for the 8 layers TX-MIMO mode might be that the maximum output power for the 8 layers TX-MIMO mode is equal to the predefined maximum output power.

According to a second aspect a network node for a wireless communication system is provided. The network node comprises a node radio transceiver configured to receive from a device comprising a radio transceiver capability information including power information indicating a maximum output power for at least one of a plurality of different supported TX-MIMO modes of the radio transceiver; a processor configured to determine based on the received power information a TX-MIMO mode to be used by the device; wherein the node radio transceiver is further configured to transmit a control signal to the device, the control signal indicating the determined TX-MIMO mode. In this way it is enabled for the network node to determine the mode best suited for communication. With a network node according to the second aspect it is enabled to use a device with a radio transceiver having different maximum output power in the different TX-MIMO modes. This greatly facilitates the design of the device with which the network node is communicating.

In a first possible implementation form of a network node according to the second aspect as such the radio transceiver is configured to receive from the device, with the capability information, TX-MIMO support information indicating the plurality of supported different TX-MIMO modes of the device; wherein the processor is configured to further determine based on the received TX-MIMO support information the TX-MIMO mode to be used by the device. With this information available it is made clear for the network node which modes that are supported.

In a second possible implementation form of a network node according to the first possible implementation form the processor is configured to, for each of the TX-MIMO modes of the plurality of supported TX-MIMO modes for which the maximum output power was not indicated in the received power information, determine the maximum output power of the corresponding TX-MIMO mode to be equal to a predefined maximum power of a predefined power class of the device. This predefined maximum power is stored in the network node or received by the network node from the device, e.g. as part of the capability information. Thus, if no maximum output power for a specific TX-MIMO mode is transmitted in the power information the network node presumes that the maximum output power for that specific TX-MIMO mode is equal to a predefined maximum power of a predefined power class of the device. The power class of the device could be typically sent from the device to the network node within the capability information.

In a third possible implementation form of a network node according to the first or second possible implementation form the TX-MIMO support information indicates only the highest supported TX-MIMO mode of the plurality of different supported TX-MIMO modes of the device; wherein the processor is configured to determine based on the received TX-MIMO support information that the device in addition to the highest supported TX-MIMO mode (indicated in the TX-MIMO support information) also supports all available lower TX-MIMO modes. This minimizes the information that has to be sent from the device to the network node.

According to a third aspect a method in a device for a wireless communication system is provided; the device comprising a radio transceiver configured to transmit data signals in a plurality of different supported transmit Multiple Input Multiple Output, MIMO, TX-MIMO, modes; the method comprising transmitting capability information including power information indicating a maximum output power for at least one of the plurality of different supported TX-MIMO modes.

With a method according to the third aspect the device may be constructed with power amplifiers of only two different sizes, only one of which being a power amplifier with full output power and the remainder of the power amplifiers being power amplifiers with a reduced output power. Power amplifiers with a reduced output power are cheaper to produce and require less space on the circuit board.

According to a fourth aspect a method for a network node for a wireless communication system is provided, the network node comprising a node radio transceiver; the method comprising receiving, from a device comprising a radio transceiver, capability information including power information indicating a maximum output power for at least one of a plurality of different supported TX-MIMO modes of the radio transceiver; determining based on the received power information a TX-MIMO mode to be used by the device; transmitting a control signal to the device, the control signal indicating the determined TX-MIMO mode. In this way it is enabled for the network node to determine the mode best suited for communication. With a network node according to the second aspect it is enabled to use a device with a radio transceiver having different maximum output power in the different TX-MIMO modes. This greatly facilitates the design of the device with which the network node is communicating.

The methods described herein may be supplemented by the features of the corresponding apparatuses.

According to a fifth aspect a computer program is provided with a program code for performing, when the computer program runs on a computer, a method according to any of the first to ninth possible implementation forms of the method or the third aspect as such or any of the first to third implementation forms of a method for a network node or to the fourth aspect as such.

### SHORT DESCRIPTION OF THE DRAWINGS

FIG. 1 shows a device for a wireless communication system according to a first embodiment.

FIG. 2 shows a device for a wireless communication system according to a second embodiment.

FIG. 3 shows schematically the device of FIG. 1 or 2 in a wireless communication system.

FIG. 4 is a flow diagram showing an embodiment of a method in a device for a wireless communication system.

FIG. 5 is a flow diagram showing an embodiment of a method in a network node for a wireless communication system.

### DETAILED DESCRIPTION

Below a description of embodiments will follow. In the following description of embodiments of the application the same reference numerals will be used for the same features in the different drawings.

In the following description of embodiments similar features in the different embodiments will be denoted with the same reference numeral.

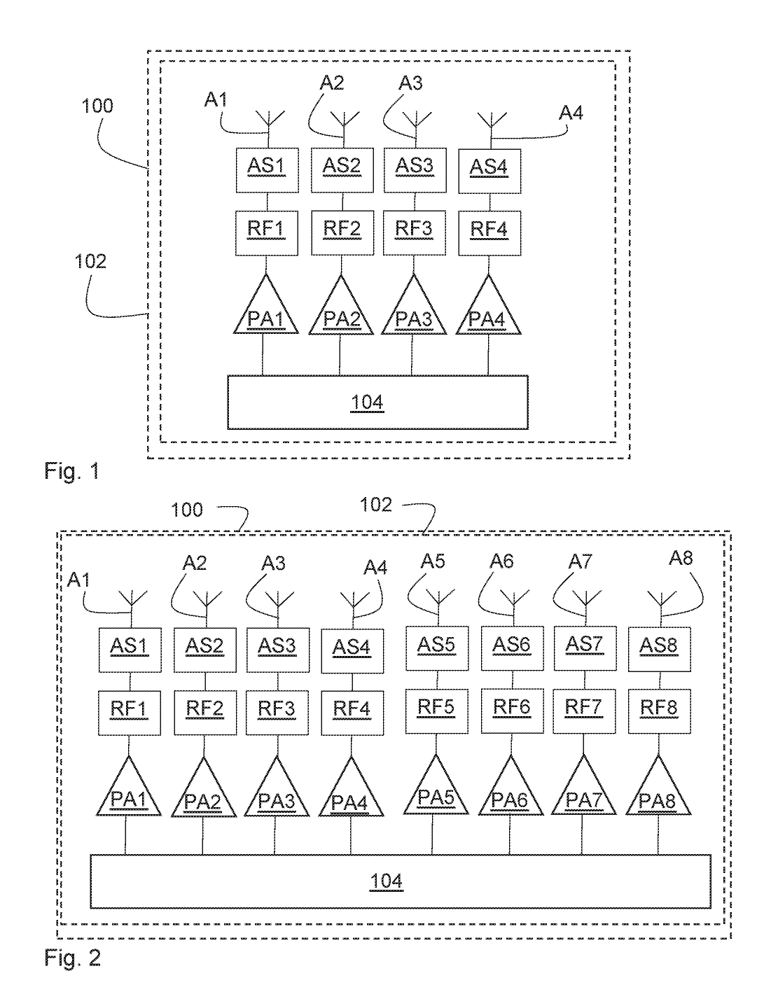

FIG. 1 shows a device 100 for a wireless communication system 500 (FIG. 5) according to a first embodiment. The device 100 comprises a radio transceiver 102 configured to transmit data signals in a plurality of different supported transmit Multiple Input Multiple Output, MIMO, TX-MIMO, modes as will be described further below. The radio transceiver 102 comprises four power amplifiers PA1, PA2, PA3, PA4, and a control unit 104 which feeds the power amplifiers PA1-PA4 with feed signals. The radio transceiver 102 also comprises four antennas A1, A2, A3, A4, four RF filters RF1, RF2, RF3, RF4 and four antenna switches AS1, AS2, AS3, AS4. Each antenna A1-A4, is connected to a separate one of the power amplifiers PA1-PA4 via a separate one of the RF filters RF1-RF4 and a separate one of the antenna switches AS1-AS4.

The control unit 104 controls the power amplifiers and uses only the first power amplifier PA1, the first RF filter RF1 and the first antenna in a single transmit mode. The maximum output power for the single transmit mode is equal to a predefined maximum output power. The transceiver can also transmit in a 2 layers TX-MIMO mode, and a 4 layers TX-MIMO mode. In the 2 layers TX-MIMO mode the transceiver 102 uses the first power amplifier PA1 and the second power amplifier PA2 and the corresponding RF filters and antenna switches to transmit the data signals. In the 4 layers TX-MIMO the transceiver 102 uses all four power amplifiers PA1-PA4 and the corresponding RF filters RF1-RF4 and antenna switches AS1-AS4. All power amplifiers 110 are configured to operate in the same frequency band. The radio transceiver 102 is further configured to transmit power information indicating a maximum output power for each one of the plurality of different supported TX-MIMO modes. The radio transceiver 102 is further configured to transmit e.g. as part of the capability information TX-MIMO support information indicating the plurality of different supported TX-MIMO modes. The radio transceiver 102 is further configured to transmit the TX-MIMO support information and the power information in one and the capability information message. The device 100 could belong to a predefined power class having a predefined maximum output power. Hence, the capability information can also comprise information on the power class of the device 100.

As an alternative the radio transceiver 102 could be configured to include in the TX-MIMO support information only the highest supported TX-MIMO mode of the plurality of different supported TX-MIMO modes. It would be presumed by a receiver of the capability information that all lower TX-MIMO modes are supported by the radio transceiver 102.

As another alternative the radio transceiver 102 could be configured to include in the power information the maximum output power for each of the plurality of different supported TX-MIMO modes, for which the maximum output power is below the predefined maximum output power. It would be presumed by a receiver of the power information that all other supported TX-MIMO modes have a maximum output power being equal to the predefined maximum output power.

Furthermore as already mentioned before, the radio transceiver 102 can be configured to include in the capability information power class information indicating the power class of the device or radio transceiver 102, such as a UE power class indicating the output power of the radio transceiver 102.

According to the most common power class for UEs the output power of a radio transceiver 102 is maximized to 23 dBm irrespective of the TX-MIMO in which the radio transceiver 102 is configured to transmit data signals. When the radio transceiver 102 is configured to transmit data signals in the single transmit mode only the first power amplifier PA1 is used. The output power from the first antenna A1 should then be 23 dBm. Due to losses in the first antenna switch AS1 and the first RF-filter RF1, 5 dBm is lost in said components. Thus, the first power amplifier PA1 has to have a maximum output power of 28 dBm in order to reach 23 dBm from the first antenna. When the radio transceiver 102 is configured to transmit data signals in 2 TX-MIMO mode the first power amplifier PA1 is used simultaneously with the second power amplifier PA2. As the maximum output power from the radio transceiver shall still be 23 dBm the maximum output power from each power amplifier must be lower than 28 dBm in order not to exceed the predefined maximum output power of 23 dBm from the radio transceiver 102. The first power amplifier could apply a 3 dBm back-off while the second power amplifier could have a maximum output power of 25 dBm. This would result in a maximum output power from the radio transceiver 102 of 10×LOG 10(2×10̂(25/10))−5=23 dBm. However, in order to simplify the radio transceiver 102 it is preferable to have the maximum output power from the second power amplifier of 22 dBm. This results in that the radio transceiver 102 has a maximum output power of 10×LOG 10(2×10̂(22/10))−5=20 dBm. Preferably, the third power amplifier PA3 and the fourth power amplifier both have a maximum output power of 22 dBm. When the radio transceiver 102 is configured to transmit data signals in 4 TX-MIMO mode the maximum output power of the radio transceiver is 10×LOG 10(2×10̂(22/10))−5=23 dBm, which is again equal to the predefined maximum output power.

The device 100 is configured to send the capability information when establishing contact with a new base station. For the device 100 described in FIG. 1 the capability information at least comprises the information that the radio transceiver 102 can be configured to transmit data signals in 4 TX-MIMO mode and that the maximum output power in 2 TX-MIMO mode is 20 dBm. Typically the capability information also comprises the information about the power class (in this case 23 dBm). From this information the receiving network node will presume that the radio transceiver 102 of the device 100 can be configured to operate also in 2 TX-MIMO mode and that the maximum output power in 4 TX-MIMO mode is 23 dBm.

FIG. 2 shows a device 100 for a wireless communication system according to a second embodiment. Only the differences between the embodiment in FIG. 1 and the embodiment in FIG. 2 will be described. In addition to the four power amplifiers PA1-PA4 in the radio transceiver 102 in FIG. 1, the radio transceiver 102 in FIG. 2 also comprises a fifth power amplifier PA5, a sixth power amplifier PA6, a seventh power amplifier PA7, and an eighth power amplifier PA8. This means that the radio transceiver 102 in the device 100 according to this second embodiment may be configured to operate also in an 8 layers TX-MIMO mode. However, the maximum output power of the power amplifiers cannot be 22 dBm as this would lead to a too high maximum output power from the radio transceiver 102 in 8 TX-MIMO mode. Thus, the maximum output power of the second to the eighth power amplifier is preferably 19 dBm, while the maximum output power of the first power amplifier is still 23 dBm so that the radio transceiver 102 can provide 23 dBm of maximum output power when the radio transceiver 102 is configured to transmit data signals in the single transmit mode. When the radio transceiver 102 is configured in 8 TX-mode the first power amplifier PA1 is operated with 9 dBm back-off. This will result in a maximum output power in 8 TX-MIMO mode of 10×LOG 10(8×10̂(19/10))−5=23 dBm. In 2 TX-MIMO mode the maximum output power will be 10×LOG 10(2×10̂(19/10))−5=17 dBm and in 4 TX-MIMO mode the maximum output power will be 10×LOG 10(4×10̂(19/10))−5=20 dBm. Accordingly, the radio transceiver 102 would transmit the capability information that the radio transceiver 102 is capable of transmitting in 8 TX-MIMO mode (TX-MIMO support information) and that it supports 17 dBm in 2 TX-MIMO mode and 20 dBm in 4 TX-MIMO mode (power information). The receiving end (e.g. a base station) would conclude that the radio transceiver is able to operate the following modes: single TX at device power class, 2 TX-MIMO at 17 dBM, 4 TX-MIMO at 20 dBm and 8 TX-MIMO at device power class.

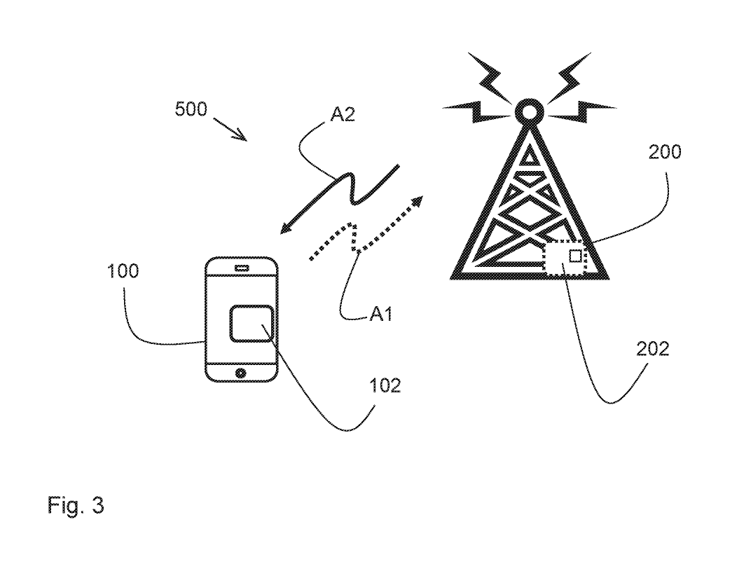

FIG. 3 shows schematically a device 100 in a wireless communication system 500. The device 100 comprises a radio transceiver 102 according to an embodiment of the application. The wireless communication system 500 also comprises a network node 200 which comprises a node radio transceiver 202. The dotted arrow A1 represents transmissions from the transceiver 102 to the network node 200, which are usually called uplink transmissions. The full arrow A2 represents transmissions from the network node 200 to the device 100, which are usually called downlink transmissions.

The device 100 may be any of a User Equipment (UE) in Long Term Evolution (LTE), mobile station (MS), wireless terminal or mobile terminal which is enabled to communicate wirelessly in a wireless communication system, sometimes also referred to as a cellular radio system. The UE may further be referred to as mobile telephones, cellular telephones, computer tablets or laptops with wireless capability. The UEs in the present context may be, for example, portable, pocket-storable, hand-held, computer-comprised, or vehicle-mounted mobile devices, enabled to communicate voice or data, via the radio access network, with another entity, such as another receiver or a server. The UE can be a Station (STA), which is any device that contains an IEEE 802.11-conformant Media Access Control (MAC) and Physical Layer (PHY) interface to the Wireless Medium (WM).

The radio network nodes may be of different classes such as, e.g., macro eNodeB, home eNodeB or pico base station, based on transmission power and thereby also cell size. The radio network node can be a Station (STA), which is any device that contains an IEEE 802.11-conformant Media Access Control (MAC) and Physical Layer (PHY) interface to the Wireless Medium (WM).

The network node 200 comprising the node radio transceiver 202 is configured to receive from the device 100 comprising the radio transceiver 102 capability information including power information indicating a maximum output power for at least one of a plurality of different supported TX-MIMO modes of the radio transceiver 102 a processor 204 configured to determine based on the received power information a TX-MIMO mode to be used by the device 100. The node radio transceiver 202 is further configured to transmit a control signal to the device 100, the control signal indicating the determined TX-MIMO mode. It is sufficient if the power information indicates the maximum output power for the TX-MIMO modes for which the maximum output power is below the predefined maximum output power. The processor 204 is configured to, for each of the TX-MIMO modes of the plurality of supported TX-MIMO modes for which the maximum output power was not indicated in the received power information, determine the maximum output power of the corresponding TX-MIMO mode to be equal to a predefined maximum power of a predefined power class of the device 100. In case the communication system allows devices of different power classes the device 100 can communicate to the network node which power class it belongs to. The node radio transceiver 202 is also configured to receive from the device 100 as part of the capability information TX-MIMO support information indicating the plurality of supported different TX-MIMO modes of the device 100; wherein the processor 204 is configured to further determine based on TX-MIMO support information the TX-MIMO to be used by the device 100. It is sufficient if the TX-MIMO support information includes only the highest supported TX-MIMO mode of the plurality of different supported TX-MIMO modes of the device 100. The processor 204 is configured to determine based on the received TX-MIMO support information that the device 100 in addition to the highest supported TX-MIMO mode included in the capability information also supports all available lower TX-MIMO modes.

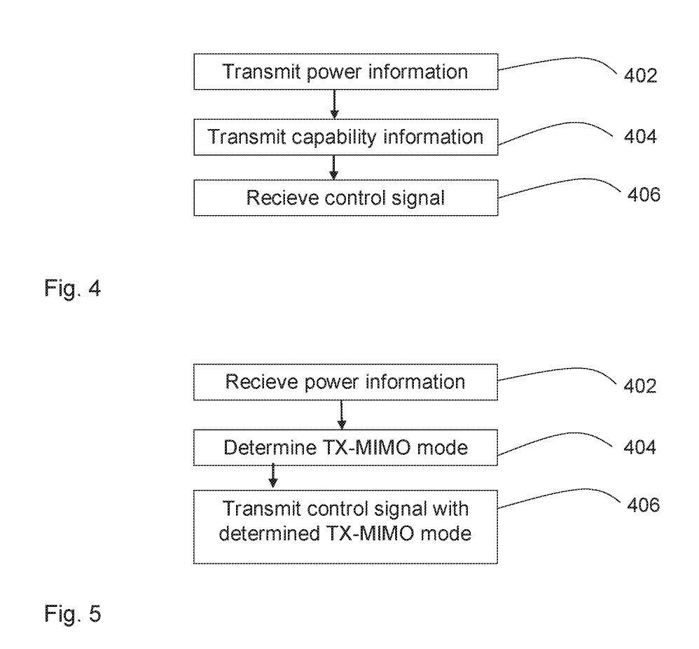

FIG. 4 is a flow diagram showing an embodiment of a method in a device 100 for a wireless communication system. The device 100 comprises a radio transceiver 102 configured to transmit data signals in a plurality of different supported transmit Multiple Input Multiple Output, MIMO, TX-MIMO, modes as was described above in relation to FIG. 1 and FIG. 2 above. The method 400 comprises transmitting 402 power information indicating a maximum output power for at least one of the plurality of different supported TX-MIMO modes, transmitting 404 capability information indicating the plurality of different supported TX-MIMO modes, receiving 406 a control signal indicating the determined TX-MIMO mode, and configuring the transceiver to transmit data signals in the determined TX-MIMO mode.

FIG. 5 is a flow diagram showing an embodiment of a method 600 in a network node 200 for a wireless communication system 500. The network node 200 comprises a node radio transceiver 202. The method 600 comprises receiving 602, from a device 100 comprising a radio transceiver 102, power information indicating a maximum output power for at least one of a plurality of different supported TX-MIMO modes of the radio transceiver 102; determining 604 based on the received power information a TX-MIMO mode to be used by the device 100; and transmitting 606 a control signal to the device 100, the control signal indicating the determined TX-MIMO mode.

What is claimed is:

1. A device for a wireless communication system, the device comprising:
a radio transceiver configured to transmit data signals in a plurality of different supported transmit Multiple Input Multiple Output, MIMO, TX-MIMO, modes;
wherein the radio transceiver is further configured to transmit capability information including power information indicating a maximum output power for at least one of the plurality of different supported TX-MIMO modes.

2. The device according to claim 1,
wherein the radio transceiver is further configured to include in the capability information TX-MIMO support information indicating the plurality of different supported TX-MIMO modes.

3. The device according to claim 2,
wherein the radio transceiver is further configured to indicate in the TX-MIMO support information only the highest supported TX-MIMO mode of the plurality of different supported TX-MIMO modes.

4. The device according to claim 2,
wherein the radio transceiver is further configured to transmit the capability information in a single message.

5. The device according to claim 1,
wherein the device belongs to a predefined power class having a predefined maximum output power;
wherein the radio transceiver is configured to include in the power information the maximum output power for each of the plurality of different supported TX-MIMO modes, for which the maximum output power is below the predefined maximum output power.

6. The device according to claim 5,
wherein the radio transceiver is configured to not include in the power information the maximum output power for each of the plurality of different supported TX-MIMO modes, for which the maximum output power is equal to the predefined maximum output power.

7. The device according to claim 1,
wherein the radio transceiver is further configured to transmit data signals in a single transmit mode;
wherein a maximum output power for the single transmit mode is equal to a maximum output power of the TX-MIMO mode or TX-MIMO modes of the plurality of different supported TX-MIMO modes having the highest maximum output power.

8. The device according to claim 1,
wherein the plurality of different supported TX-MIMO modes comprises 2 layers TX-MIMO mode, 4 layers TX-MIMO mode and 8 layers TX-MIMO mode.

9. The device according to claim 8,
wherein the radio transceiver is configured to include in the power information the maximum output power for the 2 layers TX-MIMO mode and the 4 layers TX-MIMO mode.

10. The device according to claim 9,
wherein the radio transceiver is configured to omit including in the power information the maximum output power for the 8 layers TX-MIMO mode.

11. A network node for a wireless communication system, the network node comprising
a node radio transceiver configured to
receive from a device comprising a radio transceiver capability information including power information indicating a maximum output power for at least one of a plurality of different supported TX-MIMO modes of the radio transceiver;
a processor configured to determine based on the received power information a TX-MIMO mode to be used by the device;
wherein the node radio transceiver is further configured to transmit a control signal to the device, the control signal indicating the determined TX-MIMO mode.

12. The network node according to claim 11,
wherein the node radio transceiver is configured to receive from the device, with the capability information, TX-MIMO support information indicating the plurality of supported different TX-MIMO modes of the device;
wherein the processor is configured to further determine based on the received TX-MIMO support information the TX-MIMO to be used by the device.

13. The network node according to claim 12,
wherein the processor is configured to, for each of the TX-MIMO modes of the plurality of supported TX-MIMO modes for which the maximum output power was not indicated in the received power information, determine the maximum output power of the corresponding TX-MIMO mode to be equal to a predefined maximum power of a predefined power class of the device.

14. The network node according to claim 12,
wherein the TX-MIMO support information includes only the highest supported TX-MIMO mode of the plurality of different supported TX-MIMO modes of the device;
wherein the processor is configured to determine based on the received TX-MIMO support information that the device in addition to the highest supported TX-MIMO mode also supports all available lower TX-MIMO modes.

15. A method in a device for a wireless communication system, the device comprising:
a radio transceiver configured to transmit data signals in a plurality of different supported transmit Multiple Input Multiple Output, MIMO, TX-MIMO, modes;
the method comprising
transmitting capability information including power information indicating a maximum output power for at least one of the plurality of different supported TX-MIMO modes.

16. A method in a network node for a wireless communication system, the network node comprising:
a node radio transceiver;
the method comprising
receiving, from a device comprising a radio transceiver, capability information including power information indicating a maximum output power for at least one of a plurality of different supported TX-MIMO modes of the radio transceiver;
determining based on the received power information a TX-MIMO to be used by the device;
transmitting a control signal to the device, the control signal indicating the determined TX-MIMO mode.

17. Computer program with a program code for performing a method when the computer program runs on a computer, wherein the method comprising
transmitting capability information including power information indicating a maximum output power for at least one of the plurality of different supported TX-MIMO modes.

18. Computer program with a program code for performing a method when the computer program runs on a computer, wherein the method comprising
receiving, from a device comprising a radio transceiver, capability information including power information indicating a maximum output power for at least one of a plurality of different supported TX-MIMO modes of the radio transceiver;
determining based on the received power information a TX-MIMO to be used by the device;
transmitting a control signal to the device, the control signal indicating the determined TX-MIMO mode.
